(19) United States
(12) Patent Application Publication
(10) Pub. No.: US 2014/0060475 A1
(43) Pub. Date: Mar. 6, 2014

(54) COMBUSTION CHAMBER PROVIDING VALVE CLEARANCE

(71) Applicants: Robert D. Straub, Lowell, MI (US); Paul Anthony Battiston, Clinton Township, MI (US); Amrita R. Wadhwa, Troy, MI (US)

(72) Inventors: Robert D. Straub, Lowell, MI (US); Paul Anthony Battiston, Clinton Township, MI (US); Amrita R. Wadhwa, Troy, MI (US)

(73) Assignee: GM GLOBAL TECHNOLOGY OPERATIONS LLC, Detroit, MI (US)

(21) Appl. No.: 13/597,760

(22) Filed: Aug. 29, 2012

(51) Int. Cl. F02F 1/24

(52) U.S. Cl. 123/193.5

(57) ABSTRACT

An internal combustion engine includes a piston disposed within a bore and moveable in a reciprocating motion within the bore along a central bore axis. The piston includes an axial end surface that defines a combustion chamber having a plurality of annular recesses recessed into the axial end surface of the piston. One of a plurality of valves is disposed opposite each of the plurality of annular recesses of the combustion chamber. Each of the plurality of annular recesses is axially aligned with a head of one of the plurality of valves and is sized to receive an outer perimeter of the head therein to provide clearance during valve overlap, between the axial end surface of the piston and the head of the valve, when the piston is disposed near a top dead center position.

### TECHNICAL FIELD

The invention generally relates to an internal combustion engine, and more specifically to a combustion chamber defined by an axial end surface of a piston of the internal combustion engine.

### BACKGROUND

Modern engine assemblies, including but not limited to diesel engines, include intake valves and exhaust valves that may both be disposed in an open position when a piston reaches a top dead center position. When in the open position, the valves include a head that extends into a cylinder bore of the piston to allow fluid passage therethrough. “Valve overlap” occurs when both the intake valves and the exhaust valves are simultaneously disposed in the open position. When the valves are disposed in the open position and the piston is disposed in or near the top dead center position, an axial end surface of the piston must either be spaced from the heads of the valves to avoid contacting the valves, or must define a relief or depression to provide clearance for the heads of the valves to avoid contacting the valves.

### SUMMARY

An internal combustion engine is provided. The internal combustion engine includes an engine assembly defining a bore that extends along a central bore axis. A piston is disposed within the bore. The piston is moveable in a reciprocating motion within the bore along the central bore axis. The piston includes an axial end surface that partially defines a combustion chamber. The axial end surface of the piston includes a plurality of annular recesses recessed into the axial end surface of the piston. A plurality of valves is moveably supported by the engine assembly for axial movement along the central bore axis. Each of the plurality of valves includes a head defining an outer perimeter. Each of the plurality of valves is disposed opposite one of the plurality of annular recesses of the combustion chamber. Each of the plurality of annular recesses of the combustion chamber is axially aligned with the head of one of the plurality of valves. Each of the plurality of annular recesses is sized to receive the outer perimeter of the head therein to provide clearance during valve overlap, between the axial end surface of the piston and the head of the valve, when the piston is disposed near a top dead center position.

An engine assembly is also provided. The engine assembly includes a block defining a bore that extends along a central bore axis. A cylinder head is attached to the block adjacent an axial end of the bore. A piston is disposed within the bore. The piston is moveable in a reciprocating motion within the bore along the central bore axis. The piston includes an axial end surface partially defining a combustion chamber. The combustion chamber includes a plurality of annular recesses recessed into the axial end surface of the piston. A plurality of valves is moveably supported by the cylinder head for axial movement along the central bore axis within the bore. Each of the plurality of valves includes a head defining an outer perimeter. Each of the heads of the plurality of valves is disposed opposite one of the annular recesses of the combustion chamber. When the piston is disposed in a top dead center position, the head of each of the plurality of valves overlaps the axial end surface of the piston a valve clearance distance. Each of the plurality of annular recesses of the combustion chamber is axially aligned with the head of one of the plurality of valves. Each of the plurality of annular recesses is sized to receive the outer perimeter of the head therein to provide clearance during valve overlap, between the axial end surface of the piston and the head of the valve, when the piston is disposed near the top dead center position. Each of the plurality of annular recesses defines a bottom surface that is spaced from the axial end surface of the piston a recess distance. The recess distance is greater than the valve clearance distance.

Accordingly, the axial end surface of the piston partially defines the combustion chamber, and incorporates the annular recesses into the combustion chamber. As such, the annular recesses, which provide clearance for the heads of the valves during valve overlap, are configured into the combustion chamber defined by the axial end surface of the piston, which reduces the gas volume that is not part of the combustion chamber. This allows for increased valve overlap without the use of specially dedicated valve cut-outs.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of an internal combustion engine.

FIG. 2 is a schematic perspective view of a piston of the internal combustion engine.

FIG. 3 is a schematic plan view of a piston showing a plurality of valves in phantom overlaid thereon.

FIG. 4 is a schematic perspective view of an alternative embodiment of the piston.

FIG. 5 is a schematic cross sectional view of the alternative embodiment of the piston shown in FIG. 4.

FIG. 6 is a schematic cross sectional view of an alternative embodiment of the internal combustion engine.

FIG. 7 is a schematic perspective view of a piston of the internal combustion engine shown in FIG. 6.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figures, wherein like numerals indicate like parts throughout the several views, an internal combustion engine is generally shown at 20. The internal combustion engine 20 may include but is not limited to a gasoline engine or a diesel engine.

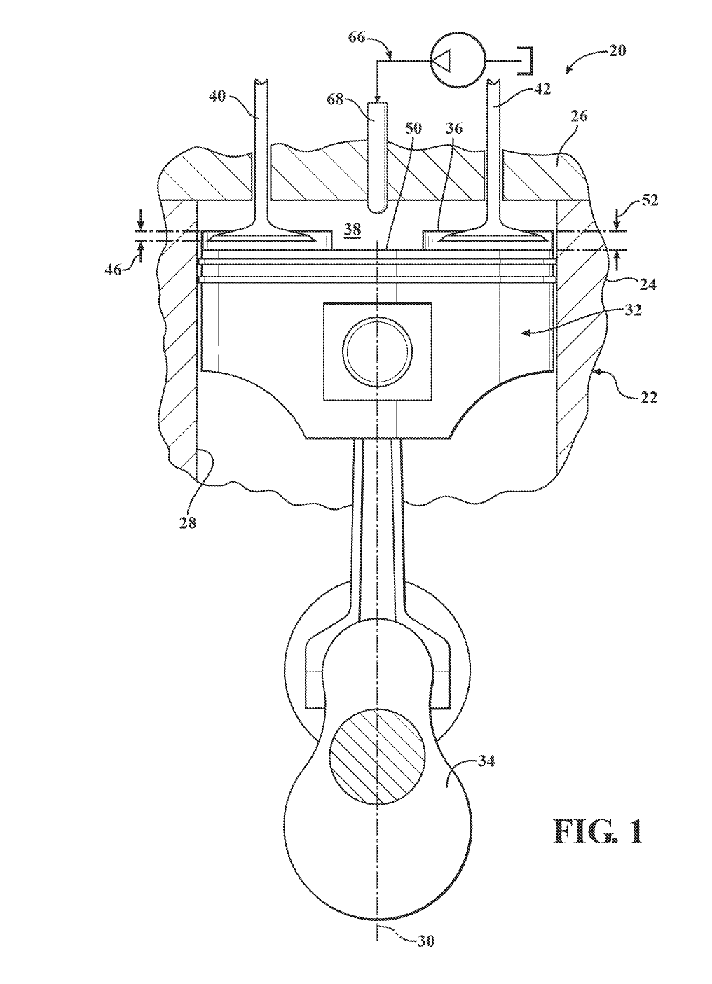

Referring to FIG. 1, the internal combustion engine 20 includes an engine assembly 22. The engine assembly 22 includes but is not limited to an engine block 24 and a cylinder head 26. The engine block 24 defines a bore 28 that extends along a central bore axis 30. The cylinder head 26 is attached to the engine block 24 adjacent an axial end of the bore 28. A piston 32 is disposed within the bore 28, and is reciprocally moveable within the bore 28 along the central bore axis 30 to drive rotation of a crankshaft 34. The piston 32 includes a radial center that is aligned with the central bore axis 30. The piston 32 includes an axial end surface 36 that cooperates with the engine block 24 and the cylinder head 26 to define a combustion chamber 38 therebetween.

A plurality of valves 40, 42 are moveably supported by the engine assembly 22, and more specifically by the cylinder head 26, for axial movement along the central bore axis 30. The plurality of valves 40, 42 includes at least one intake valve 40 and at least one exhaust valve 42. FIG. 1 shows one intake valve 40 and one exhaust valve 42. However, referring to FIG. 3, two intake valves 40 and two exhaust valves 42 are shown in phantom. It should be appreciated that the internal combustion engine 20 may include any number of intake valves 40 and exhaust valves 42, including two, three, four, etc. Each of the valves 40, 42 is moveable between a closed position and an open position. Each of the valves 40, 42 includes a head defining an outer perimeter 44 (shown in FIG. 3). When in the closed position, the heads of the valves 40, 42 are sealed against the cylinder head 26 to close fluid communication between the cylinder head 26 and the bore 28. When in the open position, such as shown in FIG. 1, the heads of the valves 40, 42 extend into the bore 28 to open fluid communication between the cylinder head 26 and the bore 28. “Valve overlap” is defined herein as occurring when both the intake valves 40 and the exhaust valves 42 are simultaneously disposed in the open position. When the valves 40, 42 are disposed in the open position and the piston 32 is disposed in or near a top dead center position, shown in FIG. 1, the head of each of the valves 40, 42 may overlap the axial end surface 36 of the piston 32 a valve clearance distance 46. As used herein, the term “top dead center” is defined as the dead-center position of the piston 32 when at the top or outer end of its stroke.

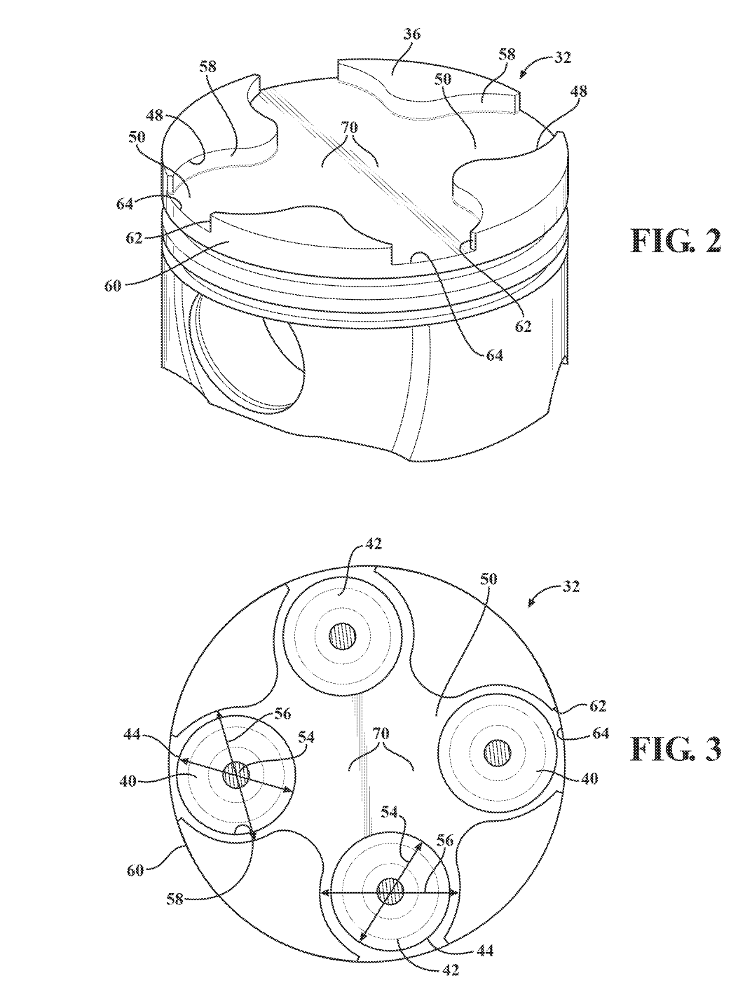

As noted above, the axial end surface 36 of the piston 32 at least partially defines the combustion chamber 38. Referring also to FIGS. 2 and 3, the portion of the combustion chamber 38 defined by the axial end surface 36 of the piston 32 includes a plurality of annular recesses 48 recessed into the axial end surface 36 of the piston 32. One of the valves 40, 42 is disposed opposite one of the annular recesses 48 of the combustion chamber 38. Each of the annular recesses 48 defines a bottom surface 50 that is spaced from the axial end surface 36 of the piston 32 a recess distance 52, shown in FIG. 1. The recess distance 52 is greater than the valve clearance distance 46. Each of the annular recesses 48 of the combustion chamber 38 is axially aligned with the head of one of the valves 40, 42, and is sized to receive the outer perimeter 44 of the head therein to provide clearance during valve overlap, between the axial end surface 36 of the piston 32 and the head of the valve. As best shown in FIG. 3, the head of each of the valves 40, 42 includes an annular shape defining a head diameter 54. Each of the annular recesses 48 includes a substantially annular shape defining a recess diameter 56. The recess diameter 56 is greater than the head diameter 54. Accordingly, when the piston 32 is disposed near the top dead center position during valve overlap, the annular recesses 48 of the combustion chamber 38 provide clearance for the heads of the valves 40, 42, and also form part of the combustion chamber 38.

Referring to FIGS. 2 and 3, each of the annular recesses 48 of the combustion chamber 38 includes an edge wall 58. The edge wall 58 of each of the annular recesses 48 extends generally parallel with the central bore axis 30, between the bottom surface 50 of the annular recess 48 and the axial end surface 36 of the piston 32. An outer peripheral wall 60 of the piston 32 may define a plurality of notches 62 disposed adjacent the axial end surface 36 of the piston 32. Each of the notches 62 defines an opening 64 into one of the annular recesses 48 of the combustion chamber 38, through the outer peripheral wall 60 of the piston 32. When the outer peripheral wall 60 of the piston 32 includes the notches 62, then the wall of the bore 28 defines a portion of the edge wall 58 of each of the annular recesses 48 adjacent each of the notches 62.

The internal combustion engine 20 may further include a direct injection fuel system 66. The direct injection fuel system 66 includes a fuel injector 68 in fluid communication with the combustion chamber 38. The fuel injector 68 injects a stream of fuel, i.e., fuel spray, into the combustion chamber 38. The fuel spray is injected into the combustion chamber 38 along a linear path. While it should be appreciated that the injected fuel spray may fan out over a distance to define a plume of injected fuel spray, a centerline of the plume extends along the straight, non-curving, linear path. Once injected into the combustion chamber 38, the fuel spray may mix with combustion air to form a fuel/air mixture. The combustion chamber 38 includes a contoured surface 70, which is partially defined by the bottom surface 50 of each of the annular recesses 48. The contoured surface 70 is contoured to re-direct the linear path of the fuel spray into a rotating vortex disposed in each of the annular recesses 48. Accordingly, it should be appreciated that the annular recesses 48 provide clearance for the heads of the valves 40, 42 during valve overlap, and also function to form the rotating vortices of the fuel/air mixture in the combustion chamber recesses 48 and/or a major vortex rotating substantially in the center of the combustion chamber 38.

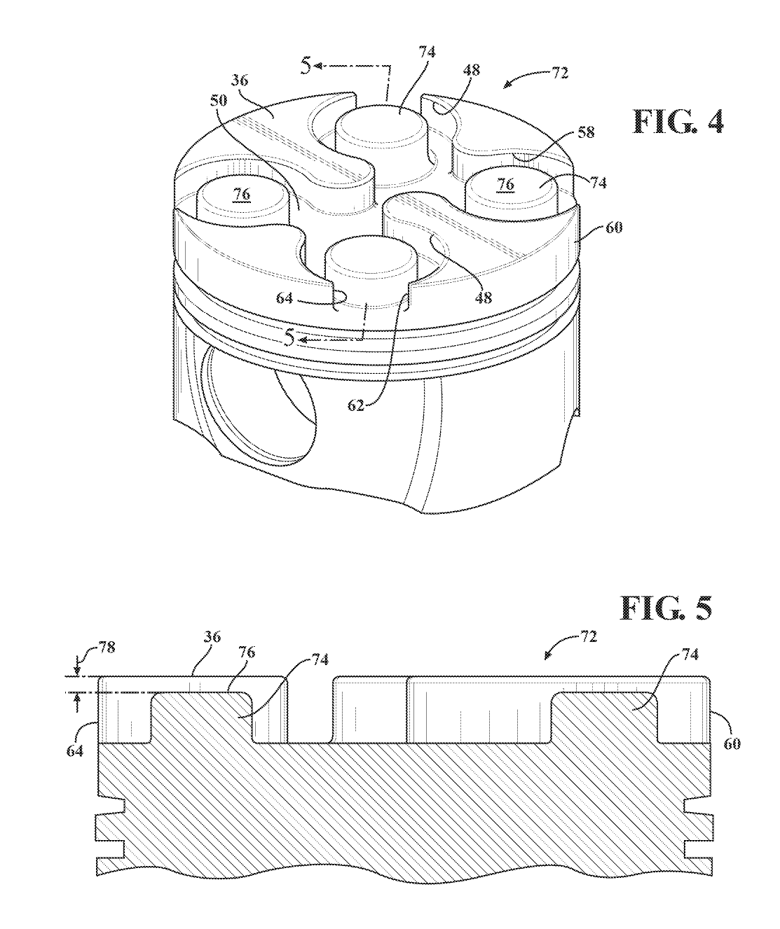

Referring to FIGS. 4 and 5, an alternative embodiment of the piston is generally shown at 72. Each of the annular recesses 48 in the axial end surface 36 of the piston 72 includes a central domed region 74. As best shown in FIG. 5, the central domed region 74 extends axially outward from the bottom surface 50 of the annular recess 48, along the central bore axis 30, and toward the head of the valve disposed opposite the annular recess 48. Each of the central domed regions 74 includes an axial tip surface 76 that is spaced inwardly from the axial end surface 36 of the piston 72 a dome recess distance 78. The dome recess distance 78 is greater than the valve clearance distance 46 to provide clearance between the heads of the valves 40, 42 and the central domed regions 74 when the piston 72 is disposed in the top dead center position during valve overlap. The central domed regions 74 are part of the contoured surface 70, and further help define the rotating vortices in the annular recesses 48.

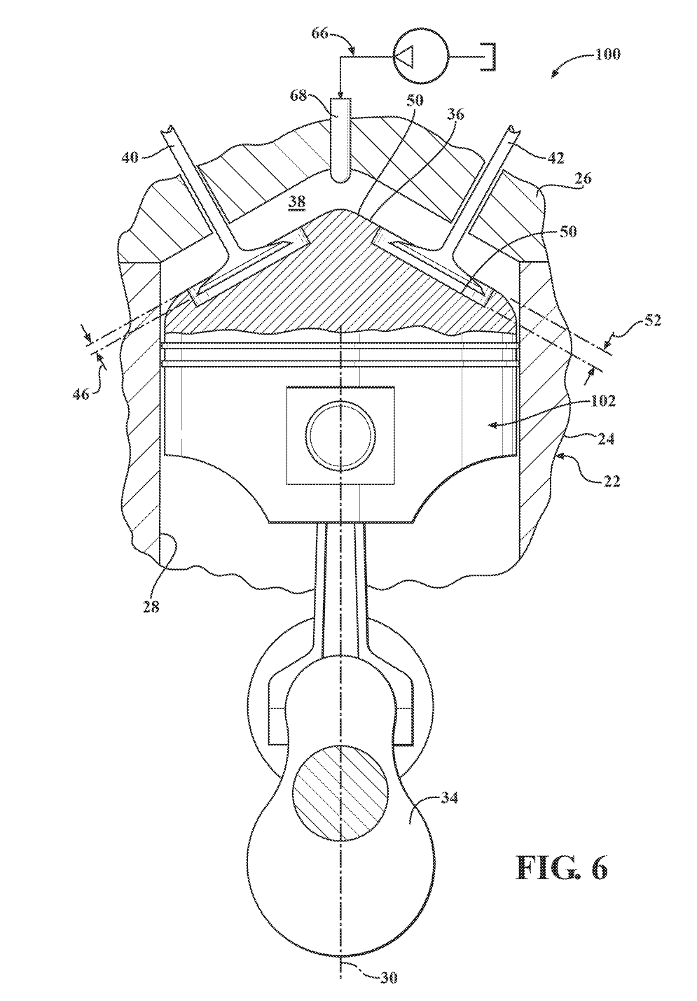

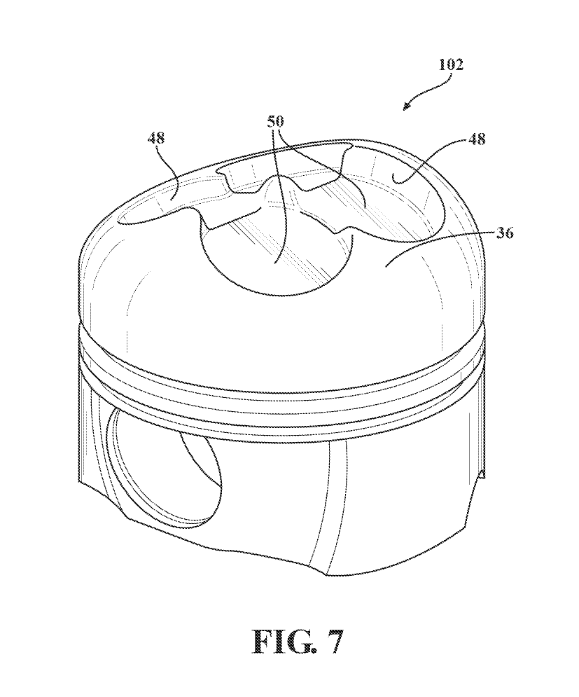

Referring to FIGS. 6 and 7, and alternative embodiment of the internal combustion engine is shown at 100. Throughout FIGS. 6, and 7, similar features include the same reference numerals used throughout FIGS. 1 through 5. The internal combustion engine 100 is a pent-roof style engine, in which the intake valves 40 and the exhaust valves 42 are arranged at an angle relative to the central axis 30. The fuel injector 68 is disposed concentrically along the central axis 30.

The internal combustion engine 100 includes a piston 102 includes an axial end surface 36 that cooperates with the engine block 24 and the cylinder head 26 to define a combustion chamber 38 therebetween. As shown in FIG. 7, the axial end surface 36 of the piston 102 includes a shape corresponding to the pent-roof shape of the cylinder head 26. When the valves 40, 42 are disposed in the open position and the piston 102 is disposed in or near a top dead center position, shown in FIG. 6, the head of each of the valves 40, 42 may overlap the axial end surface 36 of the piston 32 a valve clearance distance 46.

As noted above, the axial end surface 36 of the piston 32 at least partially defines the combustion chamber 38. Referring also to FIG. 7, the portion of the combustion chamber 38 defined by the axial end surface 36 of the piston 102 includes a plurality of annular recesses 48 recessed into the axial end surface 36 of the piston 102. One of the valves 40, 42 is disposed opposite one of the annular recesses 48 of the combustion chamber 38. Each of the annular recesses 48 defines a bottom surface 50 that is spaced from the axial end surface 36 of the piston 32 a recess distance 52, shown in FIG. 6. The recess distance 52 is greater than the valve clearance distance 46. Each of the annular recesses 48 of the combustion chamber 38 is axially aligned with the head of one of the valves 40, 42, and is sized to receive the head of the valve therein to provide clearance during valve overlap, between the axial end surface 36 of the piston 32 and the head of the valve.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An internal combustion engine comprising:
an engine assembly defining a bore extending along a central bore axis;
a piston disposed within the bore and moveable in a reciprocating motion within the bore along the central bore axis, and including an outer peripheral extending parallel with the central bore axis, and an axial end surface partially defining a combustion chamber having a plurality of annular recesses recessed into the axial end surface of the piston; and
a plurality of valves moveably supported by the engine assembly for axial movement along the central bore axis, wherein each of the plurality of valves includes a head defining an outer perimeter, and disposed opposite one of the plurality of annular recesses of the combustion chamber;
wherein each of the plurality of annular recesses of the combustion chamber is axially aligned with the head of one of the plurality of valves, and sized to receive the outer perimeter of the respective head therein to provide clearance during valve overlap between the axial end surface of the piston and the respective head of the valve when the piston is disposed near a top dead center position; and
wherein the outer peripheral wall of the piston defines a plurality of notches disposed adjacent the axial end surface of the piston, with each of the plurality of notches defining an opening into one of the plurality of annular recesses of the combustion chamber through the outer peripheral wall of the piston.

2. An internal combustion engine as set forth in claim 1 wherein the head of each of the plurality of valves overlaps the axial end surface of the piston, a valve clearance distance when the piston is disposed in the top dead center position.

3. An internal combustion engine as set forth in claim 2 wherein each of the plurality of annular recesses defines a bottom surface spaced from the axial end surface of the piston, a recess distance, wherein the recess distance is greater than the valve clearance distance.

4. An internal combustion engine as set forth in claim 2 wherein each of the plurality of annular recesses of the combustion chamber includes a central domed region extending axially outward from a bottom surface of the annular recess along the central bore axis and toward the head of the valve disposed opposite the annular recess.

5. An internal combustion engine as set forth in claim 4 wherein each of the central domed regions includes an axial tip surface spaced inwardly from the axial end surface of the piston a dome recess distance, wherein the dome recess distance is greater than the valve clearance distance.

6. An internal combustion engine as set forth in claim 1 wherein each of the plurality of annular recesses of the combustion chamber includes an edge wall extending generally parallel with the central bore axis, between a bottom surface of the annular recess and the axial end surface of the piston.

7. (canceled)

8. An internal combustion engine as set forth in claim 6 wherein the bore defines a portion of the edge wall of each of the plurality of annular recesses of the combustion chamber adjacent each of the plurality of notches.

9. An internal combustion engine as set forth in claim 1 wherein the head of each of the plurality of valves includes an annular shape defining a head diameter, and wherein each of the plurality of annular recesses includes a substantially annular shape defining a recess diameter that is greater than the head diameter.

10. An internal combustion engine as set forth in claim 1 wherein the plurality of valves includes at least one intake valve and at least one exhaust valve.

11. An internal combustion engine as set forth in claim 1 further comprising a direct injection fuel system having a fuel injector configured for injecting fuel sprays into the combustion chamber along linear paths.

12. An internal combustion engine as set forth in claim 11 wherein the combustion chamber includes a contoured surface contoured to re-direct the linear path of the fuel spray into a rotating vortex disposed in each of the plurality of annular recesses.

13. An engine assembly comprising:
a block defining a bore extending along a central bore axis;
a cylinder head attached to the block adjacent an axial end of the bore;
a piston disposed within the bore and moveable in a reciprocating motion within the bore along the central bore axis, and including an outer peripheral wall extending parallel with the central bore axis, and an axial end surface partially defining a combustion chamber and including a plurality of annular recesses recessed into the axial end surface of the piston; and
a plurality of valves moveably supported by the cylinder head for axial movement along the central bore axis within the bore, wherein each of the plurality of valves includes a head defining an outer perimeter and disposed opposite one of the annular recesses of the combustion chamber;
wherein the head of each of the plurality of valves overlaps the axial end surface of the piston by a valve clearance distance when the piston is disposed in a top dead center position;
wherein each of the plurality of annular recesses of the combustion chamber is axially aligned with the head of one of the plurality of valves, and is sized to receive the outer perimeter of the respective head therein to provide clearance during valve overlap between the axial end surface of the piston and the respective head of the valve when the piston is disposed near the top dead center position;
wherein each of the plurality of annular recesses defines a bottom surface spaced from the axial end surface of the piston a recess distance, wherein the recess distance is greater than the valve clearance distance; and
wherein the outer peripheral wall of the piston defines a plurality of notches disposed adjacent the axial end surface of the piston, with each of the plurality of notches defining an opening into one of the plurality of annular recesses of the combustion chamber through the outer peripheral wall of the piston.

14. An engine assembly as set forth in claim 13 wherein each of the plurality of annular recesses of the combustion chamber includes a central domed region extending axially outward from a bottom surface of the annular recess along the central bore axis and toward the head of the valve disposed opposite the annular recess.

15. An engine assembly as set forth in claim 14 wherein each of the central domed regions includes an axial tip surface spaced inwardly from the axial end surface of the piston a dome recess distance, wherein the dome recess distance is greater than the valve clearance distance.

16. An engine assembly as set forth in claim 13 wherein each of the plurality of annular recesses of the combustion chamber includes an edge wall extending generally parallel with the central bore axis, between a bottom surface of the annular recess and the axial end surface of the piston.

17. (canceled)

18. An engine assembly as set forth in claim 16 wherein the bore defines a portion of the edge wall of each of the plurality of annular recesses of the combustion chamber adjacent each of the plurality of notches.

19. An engine assembly as set forth in claim 13 wherein the head of each of the plurality of valves includes an annular shape defining a head diameter, and wherein each of the plurality of annular recesses includes a substantially annular shape defining a recess diameter that is greater than the head diameter.
